(19) United States
(12) Patent Application Publication
(10) Pub. No.: US 2007/0085819 A1
(43) Pub. Date: Apr. 19, 2007

(54) Look-up tables with graylevel transition waveforms for bi-stable display

(75) Inventors: Guofu Zhou, Best (NL); Jan Van De Kamer, Heerlen (NL); Mark T. Johnson, Veldhoven (NL); Neculai Ailenei, Landgraaf (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., BA Eindhoven (NL)

(21) Appl. No.: 10/575,518

(22) PCT Filed: Oct. 14, 2004
(86) PCT No.: PCT/IB04/52092

§ 371 Date: Apr. 13, 2006

(51) Int. Cl. G09G 3/34

(52) U.S. Cl. 345/107

(57) ABSTRACT

A method and system for controlling electrophoretic and other bi-stable displays (310). Coded data (605, 610, 615) for driving the display is stored in memory (320) for different pixel transitions and different temperatures. The coded data includes voltage level and timing information for the different pixel transitions. A portion (705, 710, 715, 720, 725, 730) of the coded data is retrieved by a controller (100) such as an ASIC based on a selected pixel transition, temperature, and update mode. The portion of the coded data, which may include fixed length frame instructions, is decoded to provide decoded data. The decoded data is used to provide voltage waveforms for driving the display.

The invention relates generally to electronic reading devices such as electronic books and electronic newspapers and, more particularly, to a method and apparatus for controlling a bi-stable display such as an electrophoretic display.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (e.g., Bridgestone SID2003—Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

However, electrophoretic and other bi-stable displays must be addressed and controlled in a different way than other displays such as LCDs because of their sensitivity to both the driving voltage amplitude/pulse width and the voltage signs or polarities, the relatively long switching or update time for monochrome mode updates, the even longer update time for greyscale mode updates, and sensitivity to image history.

The present invention addresses the above and other issues by providing an efficient scheme for controlling a bi-stable display.

In a particular aspect of the invention, a method for driving a display in a bi-stable device includes storing coded data for driving the display for different pixel transitions, retrieving a portion of the stored coded data based on at least a selected one of the pixel transitions, decoding the portion of the stored coded data to provide decoded data, and providing at least one voltage waveform for driving the display based on the decoded data.

A related controller and program storage device are also provided.

In the drawings:

FIG. 1 shows diagramatically a front view of an embodiment of a portion of a display screen of an electronic reading device;

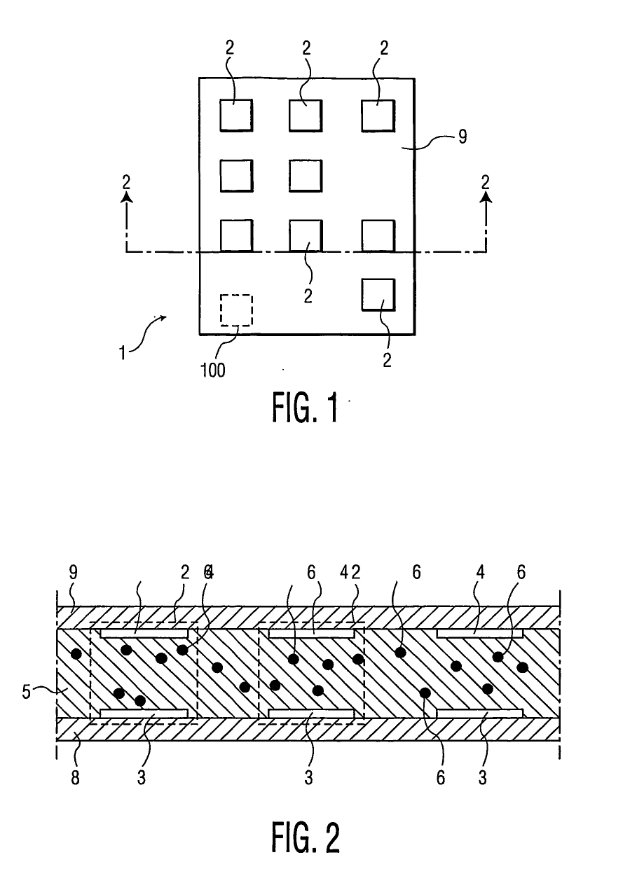

FIG. 2 shows diagramatically a cross-sectional view along 2-2 in FIG. 1;

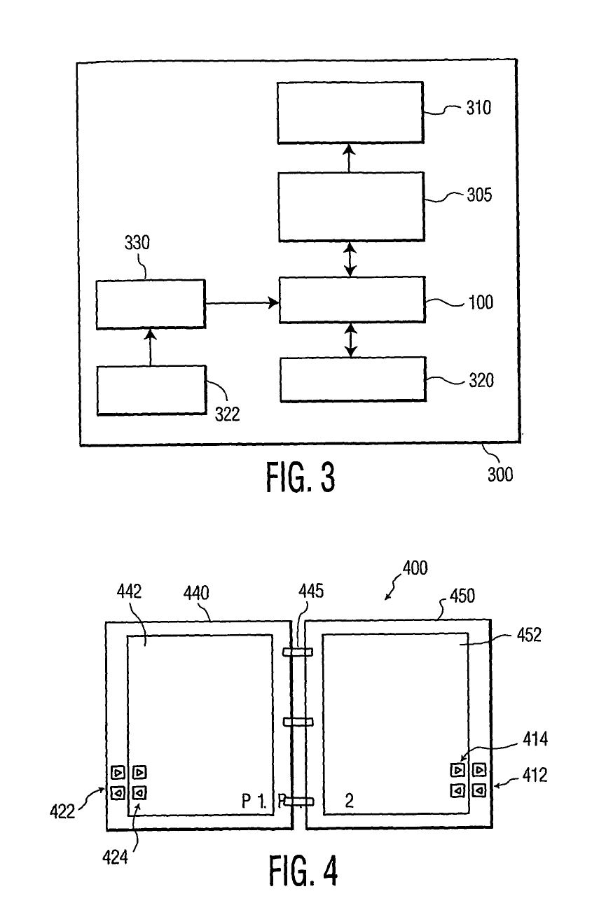

FIG. 3 shows diagramatically an overview of an electronic reading device;

FIG. 4 shows diagramatically two display screens with respective display regions;

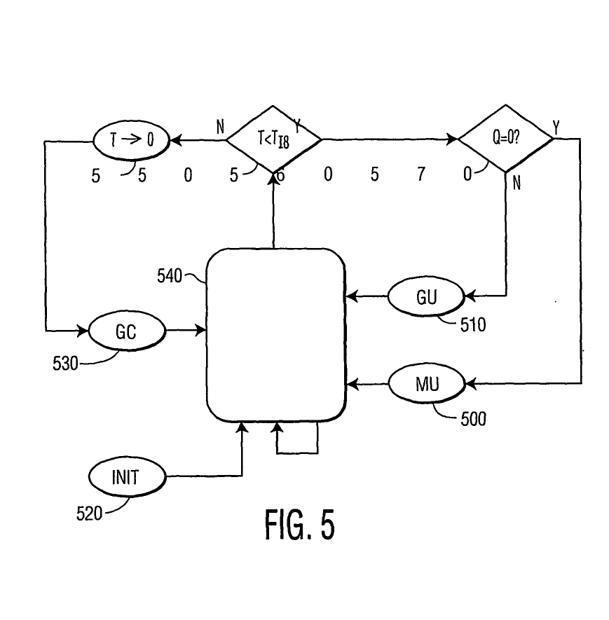

FIG. 5 illustrates an algorithm for controlling a display with multiple image update modes;

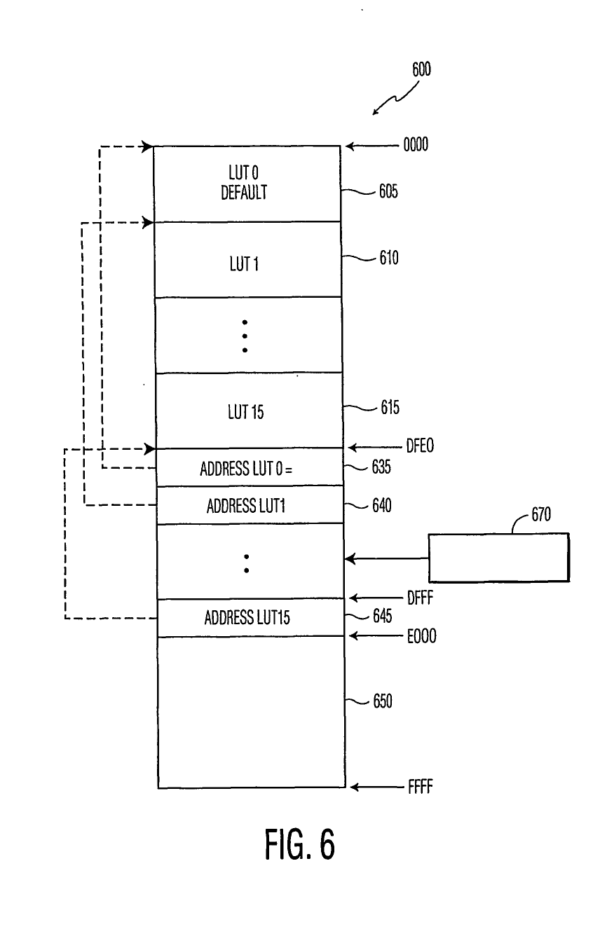

FIG. 6 illustrates a data layout in memory; and

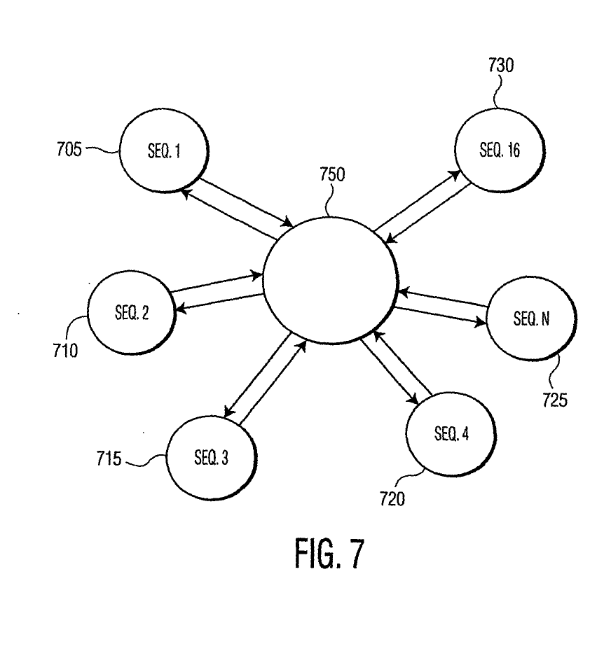

FIG. 7 illustrates conceptually the selection of a sequence based on a display update mode.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. An application-specific integrated circuit (ASIC) 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the display ASIC 100. For example, the ASIC 100 may be the Philips Corp. “Apollo” ASIC E-ink display controller. The display ASIC 100 controls the one or more display screens 310, such as electrophoretic screens, via an addressing circuit 305, to cause desired text or images to be displayed. The addressing circuit 305 includes driving integrated circuits (ICs). For example, the display ASIC 100 may provide voltage via an addressing circuit 305 waveforms to the different pixels in the display screen 310. The addressing circuit 305 provides information for addressing specific pixels, such as row and column, to cause the desired image or text to be displayed. As described further below, the display ASIC 100 causes successive pages to be displayed starting on different rows and/or columns. The image or text data may be stored in a memory 320, which represents one or more storage devices. One example is the Philips Electronics small form factor optical (SFFO) disk system, in other systems a non-volatile flash memory could be utilized. The electronic reading device 300 further includes a reading device controller 330 or host controller, which may be responsive to a user-activated software or hardware button 322 that initiates a user command such as a next page command or previous page command.

The reading device controller 330 may be part of a computer that executes any type of computer code devices, such as software, firmware, micro code or the like, to achieve the functionality described herein. Accordingly, a computer program product comprising such computer code devices may be provided in a manner apparent to those skilled in the art. The reading device controller 330 may further comprise a memory (not shown) that is a program storage device that tangibly embodies a program of instructions executable by a machine such as the reading device controller 330 or a computer to perform a method that achieves the functionality described herein. Such a program storage device may be provided in a manner apparent to those skilled in the art.

The display ASIC 100 may have logic for periodically providing a forced reset of a display region of an electronic book, e.g., after every x pages are displayed, after every y minutes, e.g., ten minutes, when the electronic reading device 300 is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The ASIC 100 provides instructions to the display addressing circuit 305 for driving the display 310 based on information stored in the memory 320, as discussed further below.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Discussion of Control Scheme

As indicated at the outset, electrophoretic and other bi-stable displays must be addressed and controlled in a different way than other displays such as LCDs because of their sensitivity to both the driving voltage amplitude/pulse width and the voltage signs, the relatively long switching or update time for monochrome mode updates, the even longer update time for greyscale mode updates, and sensitivity to image history. For example, the shortest image update time of 900 ms is achieved for greyscale image transitions. In addition, it is bi-stable/image stable and very sensitive to the image history, so there is a high risk of having image retention. Also, it is sensitive to temperature, so look-up-tables should be generated and stored for driving the display at different temperatures. The present invention provides a smart data format with high efficiency and speed, and low cost.

FIG. 5 illustrates an algorithm for controlling a display with multiple image update modes. In order to enhance the image update speed, e.g., shorten the image update time, to benefit the user, multiple display modes may be used. These modes may include, for example, a monochrome update (MU) mode 500, a greyscale update (GU) mode 510, an initialization (NIT) mode 520, and a greyscale clear (GC) mode 530. A sleep state 540 is a controller state used when waiting for a display update command. The inter-relationship between these four modes is shown. If a mode update request is made, e.g., by logic running at the reading device control 330 (a display command generated by the host), a determination is made at decision block 560 as to whether the elapsed time from the last display refresh (clear sequence) is less than a preset value. If this is true, a determination is made at decision block 570 as to whether a pixel transition flag ‘Q’ is zero. If all changed pixels have transitions from a monochrome state to a monochrome state, the flag Q will be set to zero). If this is true, MU mode 500 is selected. If the decision block 570 is false, GU mode 510 is selected. If the decision block 560 is false, the refresh timer will be cleared at block 550, and GC mode 530 is selected.

The MU mode 500 is loaded by the display ASIC, 100 when only monochrome data are updated, which occurs often in a black and white book or in a sub-window. GU mode 510 is used when at least some greyscale data in a display are updated. The total image update time with MU mode 500 is usually about half the GU mode update time. INIT mode 520 is needed when one starts using the display 310 and/or periodically afterwards, such as after every ten minutes of reading. This display sequence is used only when the system power supply (battery) has been removed, and the content of the ASIC memory has been lost. In this situation, the content of the display is unknown and the system will be initialized, clearing the display to white and writing in the ASIC memory current image as white. GC mode 530 is an option when the same level of greyscale is not updated and the display may need to be reset after a regular time.

In each mode of the display ASIC 100, each pixel receives one of thirty-two possible waveforms, depending on the data. Sixteen waveforms correspond to even pixel transitions, and sixteen corresponding to odd pixel transitions. With four possible modes, there are one hundred and twenty-eight possible waveforms that may be used to drive each pixel. Optionally, if the waveforms are not specific to even and odd pixel transitions, each pixel receives one of sixteen possible waveforms, and there are sixty-four possible waveforms that may be used to drive each pixel. The number becomes much larger when various temperatures are considered. The present invention accommodates these variables by providing a codification method/format that results in an efficient controller implementation for controlling a display such as an electrophoretic display or other bi-stable display. As mentioned in connection with FIG. 3, a dedicated controller such as the ASIC 100 may be provided according to the invention to provide instructions to the display addressing circuit 305 for driving the display 310 based on information stored in the memory 320.

FIG. 6 illustrates a data layout in memory. In each of the display modes, data is retrieved from the memory 320 for use by the ASIC 100 in driving the pixels of the display with appropriate waveforms. In accordance with one aspect of the invention, one or more frames of waveform data are provided from the memory 320 to the display ASIC 100 for driving the display 310. In particular, the waveform data may be laid out in LUTs in different locations in a memory space 600 in the memory 320. This layout may be thought of as a lookup table (LUT), although the data structure is different from a traditional LUT used, for example, in LCDs. A separate block of data is provided for each possible pixel transition. For example, when a pixel has one of four greyscale levels, namely black (B), drag grey (DG), light grey (LG), and white (W), there are sixteen possible transitions for a pixel, e.g., B to B, DG, LG, or W; DG to B, DG, LG, or W; LG to B, DG, LG, or W; and W to B, DG, LG, or W. The number of transitions is the square of the number of greyscale levels.

In the example with sixteen possible transitions, the memory space 600 includes a zeroeth LUT 605, a first LUT 610, and additional LUTs up through a fifteenth LUT 615. The zeroeth LUT 605 is designated as a default. The memory space 600 also includes the addresses at which the LUT data is stored. For example, the address for the zeroeth LUT 605 is stored in memory space 635, the address for the first LUT 610 is stored in memory space 640, and so forth, up to the address for the fifteenth LUT, which is stored in memory space 645. A memory space 650 stores controller settings and manufacturing data for the ASIC 100. An LUT select register 670 may be used to select one of the LUTs depending on the pixel transition. The memory 320 may be a non-volatile flash memory, for example.

During the display update, thirty-two waveforms are created in a number of frames with different timing. The display ASIC 100 must apply these waveforms to all display pixels according to the pixel transition. Additionally, the waveforms are applied based on a pixel parity. Pixel parity can minimize undesirable optical effects by treating the pixels in the display odd columns differently than the pixels in the display even columns. When a display update is requested, the display ASIC 100 reads the temperature and select the appropriate display sequence (collection of frame instructions) from a LUT depending on the temperature and LUT select register value. Before each frame scan is started, the display ASIC 100 reads a ‘frame instruction’ from an external non-volatile memory, e.g., memory 320, which provides the LUT space. In an example embodiment, each frame instruction is 11 bytes long. The instruction fields provide the display ASIC 100 with all necessary information about the current frame, including the voltage to be applied for each pixel depending on its transition and the frame timing. Additionally, logic is implemented for memorizing the previous state of each pixel. Based on this codification, the ASIC 100 can be designed to decode and execute this information, generating a sequence of more frames to apply the desired waveform to each pixel.

In this codification format of the waveforms for addressing the electrophoretic display, the coded waveform data may be stored in the memory 320 and decoded by the ASIC 100. The waveform data format is a new definition and could be used for all electrophoretic displays, including those using a three-voltage source driver (e.g., −15 V, 0 V, +15 V), independent of display size. The decoded data is then used by the ASIC 100 to drive the display 310.

In one possible embodiment, for each pixel of an electrophoretic display, we choose between thirty-two different waveforms. The challenge is to represent the waveforms so that they can be fetched in real time from the memory 320 during a display update. Because it is desirable to use slow (low cost) memories to reduce manufacturing costs, we are not able to read data from the memory 320 at the moment when the pixel is displayed. The waveform codification must be related to all pixels in a frame and will be read before each display frame. Also, since the waveforms depend on the display temperature, there is a link structure to implement this dependence.

The ASIC 100 uses a minimum 64 kbyte flash memory to store the temperature LUTs, the display sequences data, the controller settings and manufacturing data. Up to sixteen temperature LUTs, for instance, could be stored into the flash in the memory space between hexadecimal addresses 0 and DFDF.

The register 0×13 (670), which is associated with the ASIC 100, is used to select one of the 16 LUTs. After reset, this register is set to the default value 0, selecting the default temperature LUT from the flash address 0.

In one possible approach, each temperature LUT has 256 temperature ranges, for example, of 1° C., representing 256 pointers, for each temperature, virtual values between −128° C. up to +127° C., arranged as shown below. All pointers are represented using two flash bytes in the order MSB, LSB. The location of the default temperature LUT is fixed. It begins at the address 0 and ends at the address 1FF (hexadecimal). The flash memory locations from the address DFE0 (hexadecimal) up to address DFFF (hexadecimal) are also fixed and represent 16 address pointers to the 16 possible LUTs in the flash memory. The location between E000 and FFFF are reserved for the controller settings and manufacturing data.

Temperature LUT

The LUT address below is relative to, e.g., offset from, the base LUT address, which is indicated by the LUT pointers. The relative (rel.) addresses, e.g., offsets, are provided below, in one example.

| Rel. LUT | | | |
|---|---|---|---|
| Address (hex) | Description | Temp., ° C. | |
| 0000 | 16-bit pointer to the | 0° | C. |
| | sequences for the temp. | | |
| 0002 | 16-bit pointer to the | 1° | C. |
| | sequences for the temp. | | |
| 0004 | 16-bit pointer to the | 2° | C. |
| | sequences for the temp. | | |
| 0006 | 16-bit pointer to the | 3° | C. |
| | sequences for the temp. | | |
| . . . | | | |
| 00FE | 16-bit pointer to the | 127° | C. |
| | sequences for the temp. | | |
| 0100 | 16-bit pointer to the | −128° | C. |
| | sequences for the temp. | | |
| 0102 | 16-bit pointer to the | −127° | C. |
| | sequences for the temp. | | |
| 0104 | 16-bit pointer to the | −126° | C. |
| | sequences for the temp. | | |
| . . . | | | |
| 01FA | 16-bit pointer to the | −3° | C. |
| | sequences for the temp. | | |
| 01FC | 16-bit pointer to the | −2° | C. |
| | sequences for the temp. | | |
| 01FE | 16-bit pointer to the | −1° | C. |
| | sequences for the temp. | | |

Display Sequences/Modes.

The display should be updated using different waveforms depending on the update mode, which could be monochrome update (MU), greyscale update (GU), initialization (INIT), refresh, etc.

Every pointer from the temperature LUT represents the absolute address to a block of 16 pointers, to 16 possible display sequences (modes). As indicated in FIG. 7, a particular sequence 705, 710, 715, 720, 725 and 730 is selected based on the display update mode 750. The order of the pointers to these sequences is fixed. An example is shown below.

| Pointer | Description |
|---|---|
| seq_t0 | 16-bit address pointer to the sequence 0 |
| seq_t0 + 2 | 16-bit address pointer to the sequence 1 |
| seq_t0 + 4 | 16-bit address pointer to the sequence 2 |
| seq_t0 + 6 | 16-bit address pointer to the sequence 3 |
| seq_t0 + 8 | 16-bit address pointer to the sequence 4 |
| seq_t0 + 10 | 16-bit address pointer to the sequence 5 |
| seq_t0 + 12 | 16-bit address pointer to the sequence 6 |
| seq_t0 + 14 | 16-bit address pointer to the sequence 7 |
| seq_t0 + 16 | 16-bit address pointer to the sequence 8 |
| seq_t0 + 18 | 16-bit address pointer to the sequence 9 |
| seq_t0 + 20 | 16-bit address pointer to the sequence 10 |
| seq_t0 + 22 | 16-bit address pointer to the sequence 11 |
| seq_t0 + 24 | 16-bit address pointer to the sequence 12 |
| seq_t0 + 26 | 16-bit address pointer to the sequence 13 |
| seq_t0 + 28 | 16-bit address pointer to the sequence 14 |
| seq_t0 + 30 | 16-bit address pointer to the sequence 15 |

Each pointer to a display sequence represents the absolute address of the data for that sequence. The data format is the same for all display sequences and includes one or more records of 11 bytes length, in a particular design. The length of the record (frame instruction) can be increased if more than three driver voltages are used. After the last record, the end of the display sequence may be indicated, e.g., by the two bytes FF, as in the example below.
byte0, byte1, byte2, byte3, byte4, byte5, byte6, byte7, byte8, byte9, byte10
byte0, byte1, byte2, byte3, byte4, byte5, byte6, byte7, byte8, byte9, byte1
. . .
FFFF

When in a sequence field, and only one byte FF is encountered, the ASIC controller 100 will execute a ‘hardware shaking’. Hardware shaking is an example of a more generic form of driving pulses, known as “hardware driving”. When using hardware driving, the display is defined to operate in a mode whereby more than one line of the display is supplied with data at the same time, for example by operating more than one driver IC, such as select drivers, in parallel, or by providing multiple simultaneous outputs from a single driver IC. The cascade signals of the display gate drivers will connect the gate drivers in parallel in order to decrease the frame time to a minimum. The source driver of the display will get the data indicated after the FF byte, as indicated below:
FF shaking_data_byte FF shaking_data_byte FF shaking_data_byte FFFF

As indicated below, byte0 up to byte7 represent 32 fields of two bits. Every field represents a voltage (e.g., 00=0 V, 01=+15V, 10=−15V) applied to a display pixel, which meets the indexed condition, described for each sequence in the document. If more than the 3 voltage levels in this example are required, the field may be longer than two bits. Byte8 represents the display row time, byte9 represents the delay between two consecutive display frames, and byte10 represents the number of frames used for that sequence.

| | bit7, bit6 | bit5, bit4 | bit3, bit2 | bit1, bit0 |
|---|---|---|---|---|
| Byte0 | voltage 1 | voltage 2 | voltage 3 | voltage 4 |
| Byte1 | voltage 5 | voltage 6 | voltage 7 | voltage 8 |
| Byte2 | voltage 9 | voltage 10 | voltage 11 | voltage 12 |
| Byte3 | voltage 13 | voltage 14 | voltage 15 | voltage 16 |
| Byte4 | voltage 17 | voltage 18 | voltage 19 | voltage 20 |
| Byte5 | voltage 21 | voltage 22 | voltage 23 | voltage 24 |
| Byte6 | voltage 25 | voltage 26 | voltage 27 | voltage 28 |
| Byte7 | voltage 29 | voltage 30 | voltage 31 | voltage 32 |
| Byte8 | display row time | | | |
| Byte9 | frame delay | | | |
| Byte10N, | number frames | | | |

Each sequence has the same indexing, representing the possible pixel transitions. The 32 possible voltages in byte0 up to byte7 are associated with the indexing for each sequence as follows:

Index

| | |
|---|---|
| 1 | byte0(7:6) |
| 2 | byte0(5:6) |
| 3 | byte0(4:3) |
| . . . | |
| 32 | byte7(1:0). |

A virtual example of the matrix transition used in a display sequence is shown below for odd parity and for even parity.

Initial:

| | | | | |
|---|---|---|---|---|
| Final: | Black | Dark grey | Light grey | White |

Odd parity

| | | | | |
|---|---|---|---|---|
| Black | 1 | 5 | 9 | 13 |
| Dark grey | 2 | 6 | 10 | 14 |
| Light grey | 3 | 7 | 11 | 15 |
| White | 4 | 8 | 12 | 16 |

Even parity

| | | | | |
|---|---|---|---|---|
| Black | 17 | 21 | 25 | 29 |
| Dark grey | 18 | 22 | 26 | 30 |
| Light grey | 19 | 23 | 27 | 31 |
| White | 20 | 24 | 28 | 32 |

These are used to change the appearance of a pixel from one of four possible initial grey levels (black, dark grey, light grey, white) to one of four possible final grey levels.

Controller Settings and Manufacturing Data.

The memory space 650 in FIG. 6 may be allocated as follows:

| Address (hex) | Description |
|---|---|
| E000-E1FF | Reserved for Controller settings depending |
| | on the temperature. |
| E200 | PWM value, 0-always low, 128-50% duty cycle, |
| | 255-always high. |
| E201 | border appearance, 0-black, 1-gray1, |
| | 2-gray2, 3 white |
| E202-E3FF | Reserved for other Controller settings and |
| | manufacturing data. |
| E400-E401 | Address Pointer to Flash Program Sequence, |
| | used for autotest. |

After reset, the pulse width modulation (PWM) value and the border appearance are copied from the flash memory in two controller registers, and could be changed by the host, writing these registers:

PWM register 0×11

Border data register 0×12

Border Data

If a border is provided around the display, the display border is treated as any other display pixel and is updated at the same time with all display pixels. The default display border value is stored in the flash memory at the address E201 hexadecimal. For example, the display border value could be 0, 1, 2, 3 (black, grey1, grey2, white) and is represented by the low nibble of the byte at the address E201. After reset, the default border value is read from the flash memory, and is written in the low nibble of the internal register, border data register (address register 12 hex). The high nibble of this register is set to 0, after reset. The low nibble of the border data register represents the new border value and the high nibble represents the actual border value.

At any time, the host is able to write the low nibble of this register, using the controller's command write register (0×10) followed by the address register (0×12) and the data. When this register is written, the high nibble will get the current value of the low nibble, then the low nibble will get the host data. So, this does work like the two images in the memory, keeping the previous and the current display border value. For instance, if the border data register is written two times with the same value, the display border will be treated as a pixel having no transition. If the low nibble value is not the same with the high nibble value, the border will be treated (updated) as a pixel having a transition from ‘high nibble value’ to the ‘low nibble value’. In this way, we can force the border update in all sequences or only in the refresh sequences. Also, it is possible to change the border value any time we want.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims

1. A method for driving a display in a bi-stable device, comprising:
storing coded data (605, 610, 615) for driving the display (310) for different pixel transitions;
retrieving a portion of the stored coded data based on at least a selected one of the different pixel transitions;
decoding the portion of the stored coded data to provide decoded data; and
providing at least one voltage waveform for driving the display based on the decoded data.

2. The method of claim 1, wherein:
the stored coded data comprises voltage level and timing information for each of the different pixel transitions.

3. The method of claim 1, wherein:
the storing of the coded data comprises storing coded data for driving the display at different temperatures; and
the retrieving of the portion of the stored coded data comprises retrieving the portion of the coded data based on a selected one of the different temperatures.

4. The method of claim 1, wherein:
the retrieving of the portion of the coded data comprises retrieving at least one fixed length frame instruction.

5. The method of claim 1, wherein:
the retrieving of the portion of the coded data comprises retrieving the portion of the coded data based on a selected update mode (500, 510, 520, 530) of the display.

6. The method of claim 1, wherein:
the stored coded data comprises voltage level and timing information for each of the different pixel transitions and each of a plurality of different temperatures.

7. The method of claim 6, further comprising:
storing pointers (635, 640, 645) to the stored coded data for the different pixel transitions; and
storing relative address information for locating the stored coded data for driving the display at the plurality of different temperatures based on offsets from associated ones of the pointers.

8. An apparatus for use in driving a display in a bi-stable device, comprising:
means (100) for retrieving a portion of coded data (605, 610, 615) from a memory (320) based on at least a selected one of a plurality of different pixel transitions;
means (100) for decoding the portion of the stored coded data to provide decoded data; and
means (305) for providing at least one voltage waveform for driving the display (310) based on the decoded data;
wherein the stored coded data includes data for driving the display for the plurality of different pixel transitions.

9. The apparatus of claim 8, wherein:
the coded data comprises voltage level and timing information for each of the plurality of different pixel transitions.

10. The apparatus of claim 8, wherein:
the means for retrieving retrieves the portion of the stored coded data in at least one fixed length frame instruction.

11. The apparatus of claim 8, wherein:
the means for retrieving retrieves the portion of the stored coded data based on a selected update mode (500, 510, 520, 530) of the display.

12. The apparatus of claim 8, wherein:
the stored coded data comprises data for driving the display at different temperatures; and
the means for retrieving retrieves the portion of the stored coded data based on a selected one of the different temperatures.

13. The apparatus of claim 12, wherein:
the stored coded data comprises voltage level and timing information for each of the different pixel transitions and each of the different temperatures.

14. The apparatus of claim 8, wherein:
the display comprises an electrophoretic display.

15. A program storage device tangibly embodying a program of instructions executable by a machine to perform a method for driving a display in a bi-stable device, the method comprising:
storing coded data (605, 610, 615) for driving the display (310) for different pixel transitions;
retrieving a portion of the stored coded data based on at least a selected one of the different pixel transitions;
decoding the portion of the stored coded data to provide decoded data; and
providing at least one voltage waveform for driving the display based on the decoded data.

16. The program storage device of claim 15, wherein:
the stored coded data comprises voltage level and timing information for each of the different pixel transitions.

17. The program storage device of claim 15, wherein:
the retrieving of the portion of the coded data comprises retrieving at least one fixed length frame instruction.

18. The program storage device of claim 15, wherein:
the retrieving of the portion of the coded data comprises retrieving the portion of the coded data based on a selected update mode (500, 510, 520, 530) of the display.

19. The program storage device of claim 15, wherein:
the storing of the coded data comprises storing coded data for driving the display at different temperatures; and
the retrieving of the portion of the stored coded data comprises retrieving the portion of the coded data based on a selected one of the different temperatures.

20. The program storage device of claim 15, wherein:
the stored coded data comprises voltage level and timing information for each of the different pixel transitions and each of a plurality of different temperatures.

21. The program storage device of claim 20, wherein the method further comprises:
storing pointers (635, 640, 645) to the stored coded data for the different pixel transitions; and
storing relative address information for locating the stored coded data for driving the display at the plurality of different temperatures based on offsets from associated ones of the pointers.
